(19) United States
(12) Patent Application Publication
(10) Pub. No.: US 2003/0128479 A1
(43) Pub. Date: Jul. 10, 2003

(54) Magnetoresistive head and information reproduction apparatus

(75) Inventor: Naoki Mukoyama, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/316,620

(22) Filed: Dec. 11, 2002

(30) Foreign Application Priority Data
Jan. 10, 2002 (JP) 2002-003048

(51) Int. Cl. G11B 5/39

(52) U.S. Cl. 360/313

(57) ABSTRACT

An object of the present invention is, in a magnetoresistive head having a magnetoresistive film that exhibits a change of resistance according to a direction of magnetization wherein information is reproduced from a magnetic recording medium by detecting the change of resistance of the magnetoresistive film, and an information reproduction apparatus that reproduces information from the magnetic recording medium by detecting the change of resistance of the magnetoresistive film, to provide a magnetoresistive head with heat generation being suppressed even if a current density of a sense current through a magnetoresistive film is high, and an information reproduction apparatus provided with such a magnetoresistive head. A height of a center portion of the magnetoresistive film is shorter than a height of end portions thereof, or a width of the end portion of the magnetoresistive film varies with height.

### BACKGROUND OF THE INVENTION

1. Field of the Invention

The present invention relates to a magnetoresistive head having a magnetoresistive film that exhibits a change of resistance according to a direction of magnetization wherein information is reproduced from a magnetic recording medium by detecting the change of resistance of the magnetoresistive film, and an information reproduction apparatus that reproduces information from the magnetic recording medium by detecting the change of resistance of the magnetoresistive film.

2. Description of the Related Art

In recent years, as computers have become popular, a large quantity of information has become dealt with in daily life. Such information is recorded on a recording medium in the form of a large number of physical marks, and the information is reproduced by an information reproduction apparatus reading the marks on the recording medium and generating electrical reproduction signals.

One of the information reproduction apparatus is a hard disk drive (HDD), which has a large storage capacity and a high access speed to information. In general, the HDD comprises a magnetic disk with a surface made of a magnetic material, which constitutes a recording medium, and a magnetic head for reproducing the information recorded in the magnetic disk. The surface of the magnetic disk is magnetized on a small region (1-bit region) basis, and 1 bit of information is recorded in the form of the direction of magnetization in a 1-bit region. The magnetic head comprises a magnetoresistive film and a pair of electrode films connected to opposite ends of the magnetoresistive film, and is disposed near the magnetic disk. The magnetic head enables an electrical reproduction signal responsive to a signal magnetic field H_{sig} generated by a magnetization of a 1-bit region of the magnetic disk to be detected via the pair of electrode films, whereby the information recorded in the magnetic disk is reproduced.

The surface recording density of the magnetic disk increases from year to year. As the surface recording density becomes higher, the area of the 1-bit region becomes narrower and the signal magnetic field H_{sig} generated from the 1-bit region becomes weaker. Thus, there is a need for a magnetic head that enables a large reproduction signal to be detected even from such a weak signal magnetic field H_{sig}. As such a magnetic head that enables a large reproduction signal to be detected, a magnetoresistive head using the magnetoresistive (MR) effect is known.

Among the magnetoresistive heads, an anisotropic magnetoresistive (AMR) head having an anisotropic magnetoresistive film that exhibits the anisotropic magnetoresistive effect has been widely put into practical use.

Furthermore, a giant magnetoresistive (GMR) head having a giant magnetoresistive film that exhibits the giant magnetoresistive effect is known as a magnetoresistive head that enables a larger reproduction signal than the anisotropic magnetoresistive head to be detected. A spin valve magnetoresistive head, which is one of the giant magnetoresistive heads, is now being put into practical use.

Furthermore, a tunneling magnetoresistive (TMR) head having a tunnel junction film that exhibits the tunneling magnetoresistive effect is known as a magnetoresistive head that enables a larger reproduction signal than the anisotropic magnetoresistive head and the giant magnetoresistive head to be detected.

Now, such a magnetoresistive head having a magnetoresistive film as described above and a reproduction signal detected by the magnetoresistive head will be described.

FIG. 9 is a schematic diagram showing a magnetoresistive film and a pair of electrode films provided in a conventional magnetoresistive head, the electrode films being partially shown. FIG. 10 is a schematic view of the magnetoresistive film shown in FIG. 9.

In FIGS. 9 and 10, three arrows indicate their respective directions orthogonal to each other, X direction (height direction), Y direction (width direction) and Z direction (thickness direction). In the following description, the configuration or the like of the magnetoresistive film and electrode films will be explained using these X, Y and Z directions. Opposite directions of the X, Y and Z directions are represented by −X, −Y and −Z directions, respectively.

FIG. 9 shows a magnetoresistive film 15 and a pair of electrode films 25, 26 connected to opposite ends of the magnetoresistive film 15. As shown in FIGS. 9 and 10, the magnetoresistive film 15 comprises a pair of end portions 15a, 15b connected to the pair of electrode films 25, 26, respectively, and a center portion 15c, which is the remainder of the magnetoresistive film apart from the pair of end portions 15a, 15b, and has a length of A1 in the X direction. Hatch regions of the pair of end portions 15a, 15b of the magnetoresistive film 15 in FIG. 10 are regions which are in contact with the pair of electrode films 25, 26 shown in FIG. 9.

When reproducing the information recorded in the magnetic disk (not shown) by detecting the electrical reproduction signal responsive to the signal magnetic field H_{sig} generated from the magnetic disk, a sense current Iₛ is first supplied via the pair of electrode films 25, 26 to the magnetoresistive film 15 in the Y direction (or −Y direction). With the sense current Iₛ being supplied, the magnetoresistive film 15 is brought near to the magnetic disk (not shown) and moved with respect to the same. Then, an electrical resistance value of the magnetoresistive film 15 successively changes according to the signal magnetic field H_{sig} from the magnetic disk, and a high power reproduction signal of an output voltage represented by the product of the electrical resistance value and the sense current value is detected via the pair of electrode films 25, 26. Thus, the information recorded in the magnetic disk is reproduced.

In general, the output reproduction signal detected by the magnetoresistive head changes in proportion to a current density of the sense current Iₛ supplied to the magnetoresistive film of the magnetoresistive head via the pair of electrode films. Therefore, increasing the current density of the sense current Iₛ can provide a larger reproduction signal.

It can be contemplated that the current density of the sense current Iₛ is increased by supplying more sense current Iₛ to the magnetoresistive film. However, the more sense current Iₛ, the more heat is generated at contacts between the magnetoresistive film and the pair of electrode films in proportion to the current density of the sense current Iₛ through the magnetoresistive film. As a result, a problem, such as damage to or destruction of the magnetoresistive film, may arise.

Besides, in order to increase the current density of the sense current Iₛ through the magnetoresistive film, a technique of using the magnetoresistive film designed with a reduced length A1 is known.

However, according to the design of the magnetoresistive film with a reduced length A1, when the current density of the sense current Iₛ through the magnetoresistive film is increased, contact resistances at the contacts between the magnetoresistive film and the pair of electrode films are increased simultaneously. Also with this technique, a problem, such as damage to or destruction of the magnetoresistive film due to heat generation at the contacts, may arise.

In view of the above circumstances, an object of the present invention is to provide a magnetoresistive head with heat generation being suppressed even if a current density of a sense current through a magnetoresistive film is high, and an information reproduction apparatus provided with such a magnetoresistive head.

### SUMMARY OF THE INVENTION

A first magnetoresistive head according to the present invention that attains the object described above comprises a magnetoresistive film that exhibits a change of resistance according to a direction of magnetization of a magnetic recording medium and a pair of electrode films that are connected to the ends of the magnetoresistive film, respectively, and supply a current to the magnetoresistive film,

wherein the magnetoresistive film has a pair of end portions connected to the pair of electrode films, respectively, and a center portion located between the pair of end portions and having a height shorter than a height of the end portions.

Here, the “height” described above refers to a dimension in the X direction described with reference to FIG. 9 in the “Description of the related art”.

In the first magnetoresistive head according to the present invention, since the height of the center portion of the magnetoresistive film is shorter than that of the end portions, a contact resistance of the end portions of the magnetoresistive film at which it is connected to the pair of electrode films can be kept low. As a result, a magnetoresistive head with heat generation being suppressed even if the current density of the sense current through the magnetoresistive film is high can be provided.

Therefore, with the first magnetoresistive head according to the present invention, the current density of the sense current supplied to the magnetoresistive film can be higher than that described in the “Description of the related art”, and thus, a magnetoresistive head can be provided that enables a larger reproduction signal to be detected.

Furthermore, with the first magnetoresistive head according to the present invention, the contact resistance at the end portions of the magnetoresistive film is kept low and heat generation is suppressed as described above. Therefore, a so-called electrostatic discharge (ESD) destruction, which means a destruction of the magnetoresistive film by an electrostatic discharge, can also be suppressed.

A second magnetoresistive head according to the present invention that attains the object described above comprises a magnetoresistive film that exhibits a change of resistance according to a direction of magnetization of a magnetic recording medium and a pair of electrode films that are connected to the ends of the magnetoresistive film, respectively, and supply a current to the magnetoresistive film,

wherein the magnetoresistive film has a pair of end portions connected to the pair of electrode films, respectively, and a width of the end portions varies with height.

Here, the “width” described above refers to a dimension of the end portions, at which the magnetoresistive film is connected to the pair of electrode portions, in the Y direction described with reference to FIG. 9 in the “Description of the related art”.

In the second magnetoresistive head according to the present invention, the magnetoresistive film has the end portions having a width varying with height, and thus, if the end portions protrude toward the electrode films in the form of a triangle or wave shape, for example, the contact area of the end portions are increased. As a result, the contact resistance of the end portions can be kept low, and a magnetoresistive head with heat generation being suppressed even if the current density of the sense current through the magnetoresistive film is high can be provided as in the case of the first magnetoresistive head according to the present invention described above.

Therefore, also with the second magnetoresistive head according to the present invention, a magnetoresistive head can be provided that enables a larger reproduction signal than that of the magnetoresistive head described in the “Description of the related art” to be detected, and at the same time, the electrostatic discharge destruction can be suppressed.

Here, in the second magnetoresistive head according to the present invention, the magnetoresistive film preferably has, on the end thereof connected to the electrode film, a branch portion protruding toward the electrode film.

The magnetoresistive film with such a branch portion can readily be manufactured by a conventionally known thin film manufacturing technique.

In addition, in the second magnetoresistive head according to the present invention, the magnetoresistive film preferably has the branch portion at a position where the branch portion is located remote from the magnetic recording medium when the magnetoresistive film is positioned near or in contact with the magnetic recording medium.

In general, if the branch portion protruding toward the electrode film is located near or in contact with the magnetic recording medium, there is the possibility that a so-called crosstalk problem arises, that is, information recorded adjacent to a desired position on the magnetic recording medium is picked up.

However, with the magnetoresistive film having the branch portion located remote from the magnetic recording medium, a magnetoresistive head can be provided that avoids the crosstalk problem of the branch portion of the magnetoresistive film.

Furthermore, a first information reproduction apparatus according to the present invention that attains the object described above comprises the first magnetoresistive head described above and reproduces information from a magnetic recording medium.

The first information reproduction apparatus according to the present invention is provided with the first magnetoresistive head according to the present invention as the magnetic head to serve as the first information reproduction apparatus. Therefore, as described above with regard to the first magnetoresistive head according to the present invention, heat generation in the magnetic head is suppressed even if the current density of the sense current through the magnetoresistive film is high. Thus, the first information reproduction apparatus provided with the first magnetoresistive head reproduces information with stability and high reproduction power.

Furthermore, a second information reproduction apparatus according to the present invention that attains the object described above comprises the second magnetoresistive head described above and reproduces information from a magnetic recording medium.

The second information reproduction apparatus according to the present invention is provided with the second magnetoresistive head according to the present invention as the magnetic head to serve as the second information reproduction apparatus. Therefore, as described above with regard to the second magnetoresistive head according to the present invention, heat generation in the magnetic head is suppressed even if the current density of the sense current through the magnetoresistive film is high. Thus, as in the case of the first information reproduction apparatus described above, the second information reproduction apparatus reproduces information with stability and high reproduction power.

Here, the second information reproduction apparatus according to the present invention includes all the aspects of the information reproduction apparatus related with various aspects of the second magnetoresistive head according to the present invention.

### BRIEF DESCRIPTION OF THE DRAWINGS

FIG. 1 is a schematic structural diagram showing a hard disk drive according to an embodiment;

FIG. 2 is a schematic structural diagram showing a first embodiment of a magnetoresistive head according to the present invention;

FIG. 3 is a schematic view showing a magnetoresistive film and a pair of electrode films provided in the magnetoresistive head shown in FIG. 2, the electrode films being partially shown;

FIG. 4 is a schematic view of the magnetoresistive film shown in FIG. 3;

FIG. 5 is a schematic view of the magnetoresistive film provided in the magnetoresistive head according to a second embodiment of the present invention;

FIG. 6 is a schematic view of the magnetoresistive film provided in the magnetoresistive head according to a third embodiment of the present invention;

FIG. 7 is a schematic view of the magnetoresistive film and a pair of electrode films provided in the magnetoresistive head according to a fourth embodiment of the present invention, the electrode films being partially shown;

FIG. 8 is a schematic view of the magnetoresistive film shown in FIG. 7;

FIG. 9 is a schematic view showing the magnetoresistive film and a pair of electrode films provided in a conventional magnetoresistive head, the electrode films being partially shown; and

FIG. 10 is a schematic view of the magnetoresistive film shown in FIG. 9.

### DETAILED DESCRIPTION OF THE PREFERRED EMBODIMENTS

Now, embodiments of the present invention will be described.

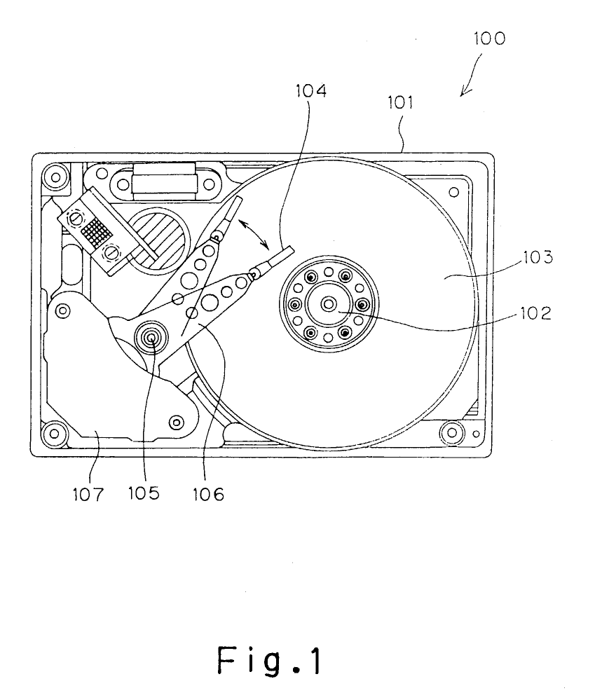

FIG. 1 is a schematic diagram showing a hard disk drive according to an embodiment of the present invention.

A hard disk drive (HDD) 100 shown in FIG. 1 is one embodiment of an information reproduction apparatus according to the present invention. A housing 101 of the HDD 100 shown in FIG. 1 houses a rotary shaft 102, a magnetic disk 103 mounted on the rotary shaft 102, a floating head slider 104 facing a surface of the magnetic disk 103 closely, an arm shaft 105, a carriage arm 106 that has the floating head slider 104 fixed to a tip thereof and pivots horizontally about the arm shaft 105 over the magnetic disk 103, and an actuator 107 for causing the carriage arm 106 to pivot horizontally.

In the HDD 100, information is recorded in the magnetic disk 103 and the information recorded in the magnetic disk 103 is reproduced. In such recording and reproduction of information, the actuator 107, which is composed of a magnetic circuit, first actuates the carriage arm 106, thereby positioning the floating head slider 104 above a desired track on the rotating magnetic disk 103. On a tip of the floating head slider 104, a combined magnetic head composed of an information recording head and an information reproducing head is mounted. As the magnetic disk 103 rotates, the combined magnetic head is successively brought near to each of 1-bit regions in each of the tracks on the magnetic disk 103. When recording information, an electrical recording signal is input to the combined magnetic head near the magnetic disk 103, and the information recording head of the combined magnetic head applies a magnetic field associated with the recording signal to each 1-bit region, whereby the information carried on the recording signal is recorded in the 1-bit region in the form of a direction of magnetization. When reproducing information, the information recorded in each 1-bit region in the form of a direction of magnetization is extracted by the information reproducing head of the combined magnetic head in the form of an electrical reproduction signal responsive to a signal magnetic field H_{sig} generated by the magnetization. An interior space of the housing 101 is enclosed by a cover, not shown. The information reproducing head of the combined magnetic head is equivalent to a first embodiment of the magnetoresistive head of the present invention described below.

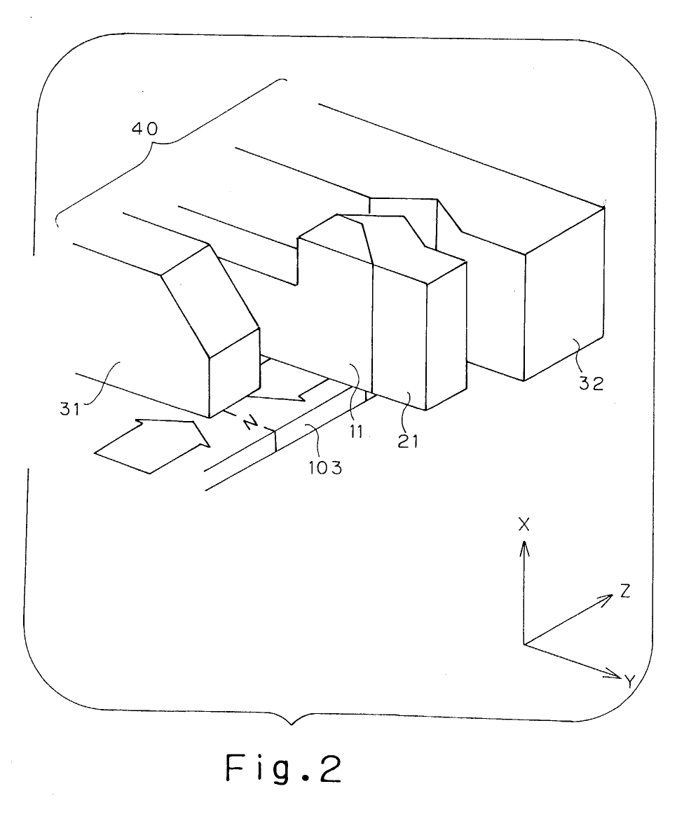

FIG. 2 is a schematic diagram showing the first embodiment of the magnetoresistive head according to the present invention.

FIG. 2 shows an information reproducing magnetoresistive head 40 of the combined magnetic head that is mounted on the tip of the floating head slider 104 and positioned near the magnetic disk 103 as shown in FIG. 1.

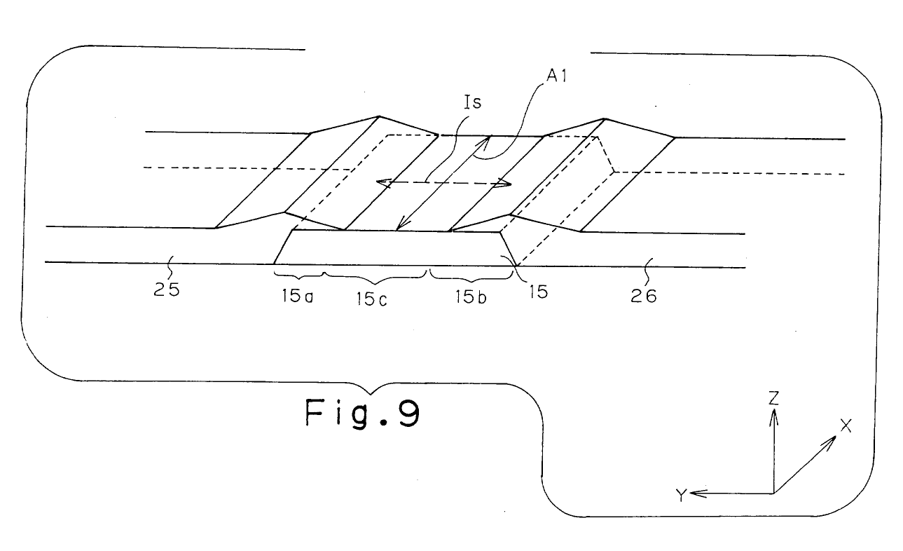

In FIG. 2, as in FIG. 9, three arrows indicate their respective directions, that is, X direction (height direction), Y direction (width direction) and Z direction (thickness direction). In the following description, the X direction, Y direction and Z direction will be used.

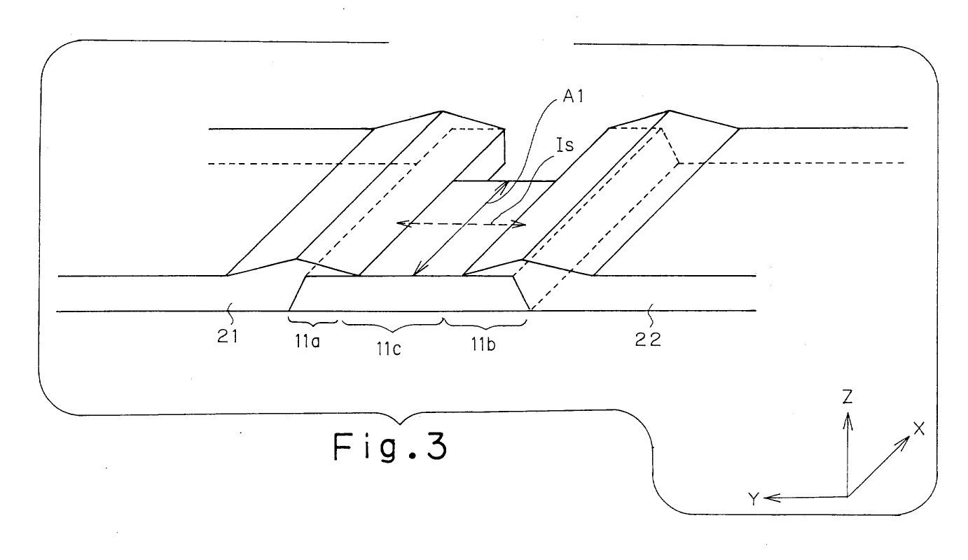

The magnetoresistive head 40 shown in FIG. 2 comprises a magnetoresistive film 11, an electrode film 21 connected to an end of the magnetoresistive film 11 toward the Y direction, an electrode film 22 (described later, see FIG. 3) connected to an end of the magnetoresistive film 11 toward the −Y direction, shield layers 31 and 32 disposed to sandwich the magnetoresistive film 11 and the pair of electrode films 21, 22 in the thickness direction (Z direction), a gap layer (not shown) disposed between the magnetoresistive film 11 and pair of electrode films 21, 22 and the shield layer 31, and a gap layer (not shown) disposed between the magnetoresistive film 11 and pair of electrode films 21, 22 and the shield layer 32.

The magnetoresistive film 11 is responsible for reproducing information in the magnetoresistive head 40. The magnetoresistive film 11 exhibits a change of resistance according to a direction of magnetization of each 1-bit region of the magnetic disk 103.

The pair of electrode films 21, 22 are each made of a conductive material and supply a sense current Iₛ to the magnetoresistive film 11. The change of resistance in the magnetoresistive film 11 is detected via the pair of electrode films 21, 22.

The shield layers 31, 32 are each made of a soft magnetic material, such as FeN, and serve to shield the magnetoresistive film 11 against an undesirable external magnetic field applied thereto.

The gap layers, not shown, are each made of an insulating material, such as Al₂O₃ (alumina), and serve to prevent a leakage current from the magnetoresistive film 11 and the pair of electrode films 21, 22.

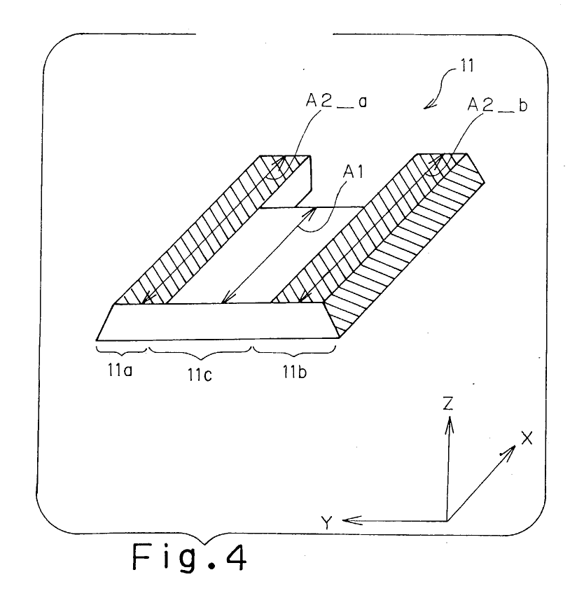

Now, configurations of the magnetoresistive film 11 and the pair of electrode films 21, 22 will be described in detail with reference to FIGS. 3 and 4.

FIG. 3 is a schematic view showing the magnetoresistive film and the pair of electrode films provided in the magnetoresistive head shown in FIG. 2, the electrode films being partially shown. FIG. 4 is a schematic view of the magnetoresistive film shown in FIG. 3.

FIG. 3 shows the magnetoresistive film 11 and the pair of electrode films 21, 22 connected to the opposite ends of the magnetoresistive film 11. As shown in FIGS. 3 and 4, the magnetoresistive film 11 comprises a pair of end portions 11a, 11b connected to the pair of electrode films 21, 22, respectively, and a center portion 11c, which is the remainder of the magnetoresistive film apart from the pair of end portions 11a, 11b. Hatch regions of the pair of end portions 11a, 11b of the magnetoresistive film 11 in FIG. 4 are regions which are in contact with the pair of electrode films 21, 22 shown in FIG. 3.

When reproducing the information recorded in the magnetic disk 103 shown in FIGS. 1 and 2 by detecting the electrical reproduction signal responsive to the signal magnetic field H_{sig} generated from the magnetic disk 103, a sense current Iₛ is first supplied via the pair of electrode films 21, 22 to the magnetoresistive film 11 in the Y direction (or −Y direction). With the sense current Iₛ being supplied, the magnetoresistive film 11 is brought near to the magnetic disk 103 shown in FIGS. 1 an 2 and moved with respect to the same. Then, an electrical resistance value of the magnetoresistive film 11 successively changes according to the signal magnetic field H_{sig} from the magnetic disk 103, and a high power reproduction signal of an output voltage represented by the product of the electrical resistance value and the sense current value is detected via the pair of electrode films 21, 22. Thus, the information recorded in the magnetic disk is reproduced.

A film length A1 in the X direction orthogonal to the Y direction in which the sense current Iₛ flows through the center portion 11c is smaller than end portion lengths A2_a and A2_b of the end portions 11a and 11b.

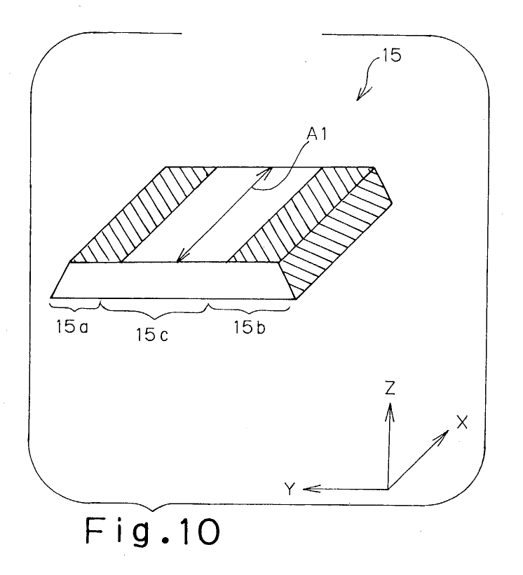

In addition, the film length A1 of the magnetoresistive film 15 described with reference to FIG. 10 in the “Description of the related art” is equal to the film length A1 of the magnetoresistive film 11 shown in FIG. 4.

Therefore, the areas of the end portions 11a, 11b of the magnetoresistive film 11 which are in contact with the pair of electrode films 21, 22, respectively, are larger than those of the magnetoresistive film 15 shown in FIG. 10. Thus, a magnetoresistive head is provided that can keep the contact resistance thereof low and suppress heat generation even if the current density of the sense current Iₛ through the magnetoresistive film 11 is high.

Conversely, if the quantity of heat generated at the contact portions of the magnetoresistive film 15 described with reference to FIGS. 9 and 10 in the “Description of the related art” is equal to the quantity of heat generated at the contact portions of the magnetoresistive film 11 shown in FIGS. 3 and 4, the area of the contact portions of the magnetoresistive film 11 is larger than that of the conventional magnetoresistive film 15, as described above. Therefore, the sense current Iₛ supplied to the magnetoresistive film 11 is more than that supplied to the conventional magnetoresistive film 15. Furthermore, the length A1 of the magnetoresistive film 11 is equal to the length A1 of the conventional magnetoresistive film 15, as described above. Therefore, the center portion of the magnetoresistive film 11, which receives the more sense current Iₛ, has a higher current density of the sense current Iₛ. As a result, a magnetoresistive head can be provided that enables a larger reproduction signal to be detected.

Furthermore, with the magnetoresistive head using the magnetoresistive film 11, since the contact resistance of the contact portions of the end portions 11a, 11b of the magnetoresistive film 11 is kept low and heat generation is suppressed as described above, a so-called electrostatic discharge (ESD) destruction, which means a destruction of the magnetoresistive film by an electrostatic discharge, can also be suppressed.

While the magnetoresistive film 11 provided in the magnetoresistive head 40 according to the first embodiment of the present invention is configured with the film length A1 shorter than the end portion lengths A2_a and A2_b, the magnetoresistive film thus configured can be readily manufactured by a conventionally known thin film manufacturing technique.

Now, a second embodiment of the magnetoresistive head of the present invention will be described.

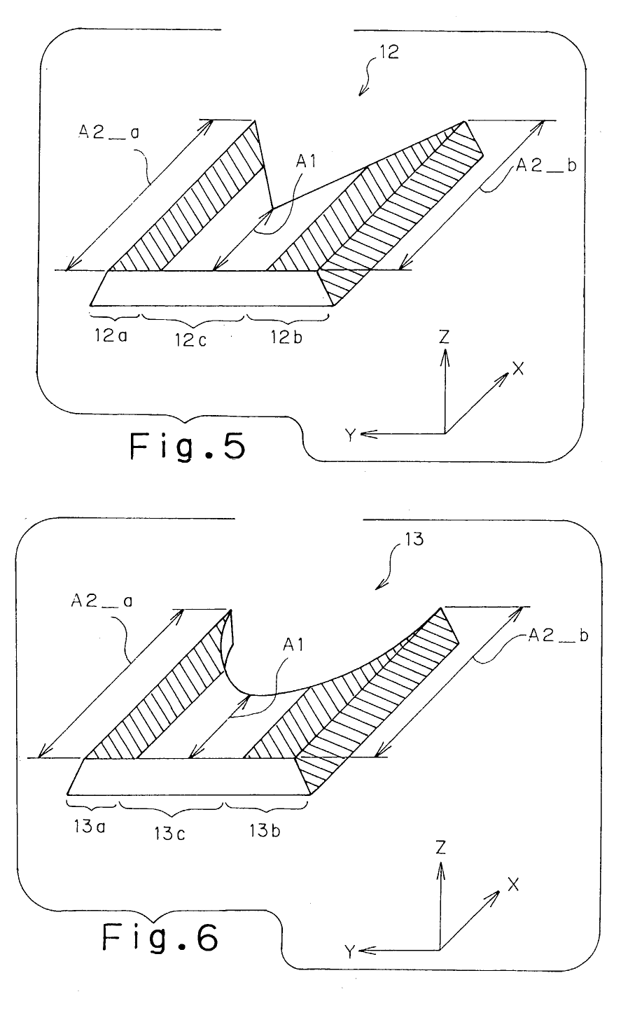

FIG. 5 is a schematic view of the magnetoresistive film provided in the magnetoresistive head according to the second embodiment of the present invention.

The magnetoresistive head of the second embodiment is the same as the magnetoresistive head of the first embodiment except that it has a magnetoresistive film 12 shown in FIG. 5 instead of the magnetoresistive film 11 shown in FIGS. 2, 3 and 4. Thus, in the following description of the second embodiment, the overlapping description will be omitted.

As in the case of the magnetoresistive film 11 shown in FIG. 4, the magnetoresistive film 12 shown in FIG. 5 comprises a pair of end portions 12a, 12b connected to a pair of electrode films (not shown), and a center portion 12c, which is the remainder of the magnetoresistive film apart from the pair of end portions 12a, 12b. In addition, the magnetoresistive film 12 has its side toward the X direction formed into a V-shape. Hatch regions of the pair of end portions 12a, 12b are regions which are in contact with the pair of electrode films, not shown.

In the magnetoresistive film 12, as in the case of the magnetoresistive film 11 shown in FIG. 4, the film length A1 of the center portion 12c is smaller than the end portion lengths A2_a and A2_b of the end portions 12a and 12b.

Therefore, as with the magnetoresistive film 11 shown in FIG. 4, with the magnetoresistive film 12 thus configured, a magnetoresistive head can be provided that suppresses heat generation even if the current density of the sense current Iₛ through the magnetoresistive film 12 is high and enables a larger reproduction signal to be detected, and at the same time, the electrostatic discharge destruction can also be suppressed.

Now, a third embodiment of the magnetoresistive head of the present invention will be described.

FIG. 6 is a schematic view of the magnetoresistive film provided in the magnetoresistive head according to the third embodiment of the present invention.

The magnetoresistive head of the third embodiment is the same as the magnetoresistive head of the first embodiment except that it has a magnetoresistive film 13 shown in FIG. 6 instead of the magnetoresistive film 11 shown in FIGS. 2, 3 and 4. Thus, in the following description of the third embodiment, the overlapping description will be omitted.

As in the case of the magnetoresistive film 11 shown in FIG. 4, the magnetoresistive film 13 shown in FIG. 6 also comprises a pair of end portions 13a, 13b connected to a pair of electrode films (not shown), and a center portion 13c, which is the remainder of the magnetoresistive film apart from the pair of end portions 13a, 13b. In addition, the magnetoresistive film 13 has its side toward the X direction formed into a U-shape. Hatch regions of the pair of end portions 13a, 13b are regions which are in contact with the pair of electrode films, not shown.

In the magnetoresistive film 13, as in the case of the magnetoresistive film 11 shown in FIG. 4, the film length A1 of the center portion 13c is smaller than the end portion lengths A2_a and A2_b of the end portions 13a and 13b.

Therefore, as with the magnetoresistive film 11 shown in FIG. 4, with the magnetoresistive film 13 thus configured, a magnetoresistive head can be provided that suppresses heat generation in the magnetoresistive film 13 and enables a larger reproduction signal to be detected, and at the same time, the electrostatic discharge destruction can also be suppressed.

Now, a fourth embodiment of the magnetoresistive head of the present invention will be described.

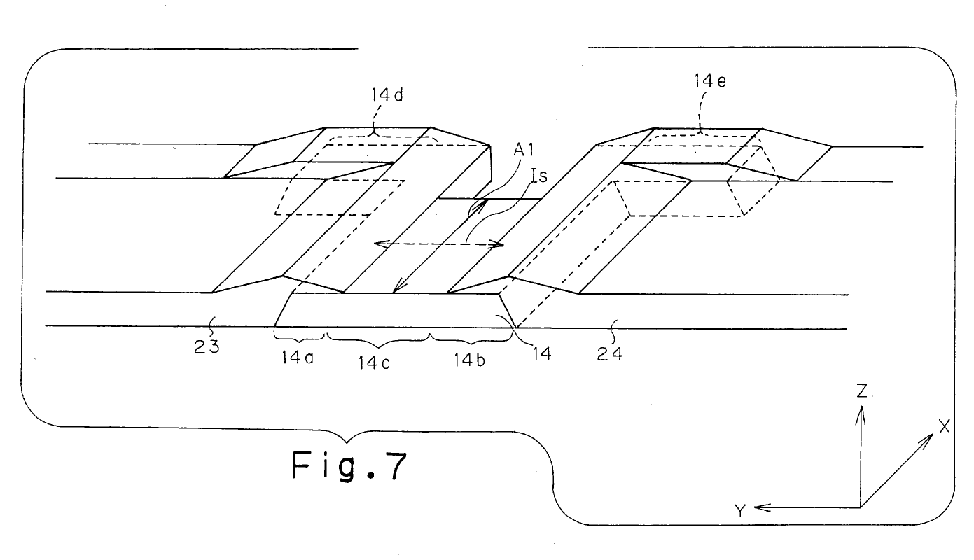

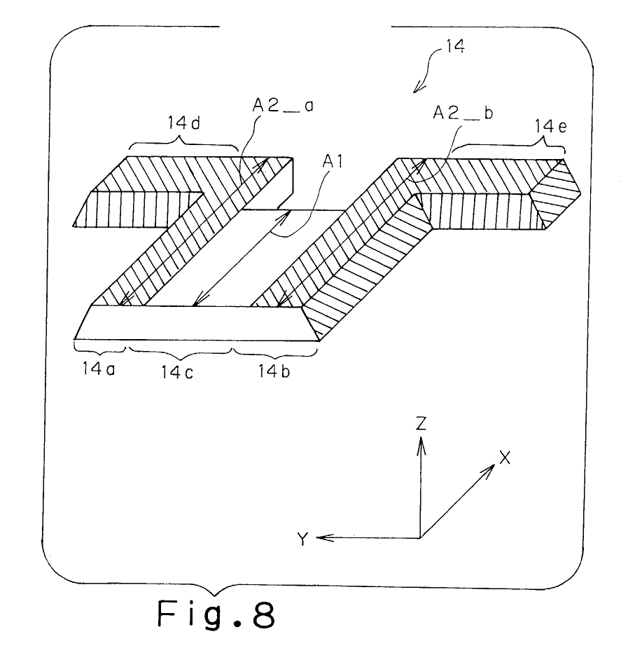

FIG. 7 is a schematic view of the magnetoresistive film and a pair of electrode films provided in the magnetoresistive head according to a fourth embodiment of the present invention, the electrode films being partially shown. FIG. 8 is a schematic view of the magnetoresistive film shown in FIG. 7.

The magnetoresistive head of the fourth embodiment is the same as the magnetoresistive head of the first embodiment described above except that it has a magnetoresistive film 14 and a pair of electrode films 23, 24 shown in FIGS. 7 and 8 instead of the magnetoresistive film 11 and the pair of electrode films 21, 22 shown in FIGS. 2, 3 and 4. Thus, in the following description of the fourth embodiment, the overlapping description will be omitted.

FIG. 7 shows the magnetoresistive film 14 and the pair of electrode films 23, 24 connected to the opposite ends of the magnetoresistive film 14. As shown in FIGS. 7 and 8, the magnetoresistive film 14 comprises a pair of end portions 14a, 14b connected to the pair of electrode films 23, 24, respectively, a branch portion 14d protruding from the end portion 14a toward the electrode film 23 (in the Y direction), a branch portion 14e protruding from the end portion 14b toward the electrode film 24 (in the −Y direction), and a center portion 14c, which is the remainder of the magnetoresistive film apart from the pair of end portions 14a, 14b and the branch portions 14d, 14e. Hatch regions of the pair of end portions 14a, 14b and the branch portions 14d, 14e of the magnetoresistive film 14 shown in FIG. 8 are regions which are in contact with the pair of electrode films 23, 24 shown in FIG. 7.

In the magnetoresistive film 14, as in the case of the magnetoresistive film 11 shown in FIG. 4, the film length A1 of the center portion 14c is smaller than the end portion lengths A2_a and A2_b of the end portions 14a and 14b.

Therefore, with the magnetoresistive film 14 thus configured, the contact area is larger than that of the magnetoresistive film 11 shown in FIG. 4 by the area of the branch portions 14d, 14e. Thus, a magnetoresistive head can be provided that suppresses further heat generation in the magnetoresistive film 14 and enables a still larger reproduction signal to be detected, and at the same time, the electrostatic discharge destruction can also be suppressed.

Furthermore, the branch portions 14d, 14e protrude toward the electrode films 23, 24 from parts of the end portions 14a, 14b toward the X direction, respectively, so that the branch portions are located remote from the magnetic disk 103 when the magnetoresistive film 14 is positioned near the magnetic disk 103 as shown in FIGS. 1 and 2.

With the magnetoresistive film 14 having the branch portions 14d, 14e thus located, a magnetoresistive head can be provided that avoids a problem that information recorded adjacent to a desired position on the magnetic disk 103 is picked up, that is, a crosstalk problem.

The present invention can be applied to any magnetic head as far as it is the magnetoresistive head using the magnetoresistive effect, for example, an anisotropic magnetoresistive head having an anisotropic magnetoresistive film, a giant magnetoresistive head having a giant magnetoresistive film and a tunneling magnetoresistive head having a tunnel junction film.

In addition, the magnetoresistive films of the magnetoresistive head according to the second to fourth embodiments of the present invention, described with reference to FIGS. 5 to 8, can be readily manufactured by a conventionally known thin film manufacturing technique, as in the case of the magnetoresistive film according to the first embodiment.

The magnetoresistive film of the magnetoresistive head according to the fourth embodiment of the present invention has been described with reference to FIGS. 7 and 8 as having the branch portions protruding from the ends thereof toward the electrode films. However, in the magnetoresistive film having the end portions each having a width varying with height according to the present invention, the end portions protruding toward the electrode films can be formed into a triangle or wave shape, for example.

As described above, according to the present invention, there are provided a magnetoresistive head with heat generation being suppressed even if a current density of a sense current through a magnetoresistive film is high, and an information reproduction apparatus provided with such a magnetoresistive head.

What is claimed is:

1. A magnetoresistive head, comprising:
a magnetoresistive film that exhibits a change of resistance according to a direction of magnetization of a magnetic recording medium and a pair of electrode films that are connected to the ends of the magnetoresistive film, respectively, and supply a current to the magnetoresistive film,
wherein said magnetoresistive film has a pair of end portions connected to said pair of electrode films, respectively, and a center portion located between the pair of end portions and having a height shorter than a height of said end portions.

2. A magnetoresistive head, comprising:
a magnetoresistive film that exhibits a change of resistance according to a direction of magnetization of a magnetic recording medium and a pair of electrode films that are connected to the ends of the magnetoresistive film, respectively, and supply a current to the magnetoresistive film,
wherein said magnetoresistive film has a pair of end portions connected to said pair of electrode films, respectively, and a width of the end portions varies with height.

3. The magnetoresistive head according to claim 2, wherein said magnetoresistive film has, on the end thereof connected to said electrode film, a branch portion protruding toward the electrode film.

4. The magnetoresistive head according to claim 3, wherein said magnetoresistive film has said branch portion at a position where the branch portion is located remote from said magnetic recording medium when the magnetoresistive film is positioned near or in contact with the magnetic recording medium.

5. An information reproduction apparatus for reproducing information from a magnetic recording medium, comprising:
a magnetoresistive head having a magnetoresistive film that exhibits a change of resistance according to a direction of magnetization of the magnetic recording medium and a pair of electrode films that are connected to the ends of the magnetoresistive film, respectively, and supply a current to the magnetoresistive film,
wherein said magnetoresistive film has a pair of end portions connected to said pair of electrode films, respectively, and a center portion located between the pair of end portions and having a height shorter than a height of said end portions.

6. An information reproduction apparatus for reproducing information from a magnetic recording medium, comprising:
a magnetoresistive head having a magnetoresistive film that exhibits a change of resistance according to a direction of magnetization of a magnetic recording medium and a pair of electrode films that are connected to the ends of the magnetoresistive film, respectively, and supply a current to the magnetoresistive film,
wherein said magnetoresistive film has a pair of end portions connected to said pair of electrode films, respectively, and a width of the end portions varies with height.

7. The information reproduction apparatus according to claim 6, wherein said magnetoresistive film has, on the end thereof connected to said electrode film, a branch portion protruding toward the electrode film.
